(19) United States
(12) Patent Application Publication
(10) Pub. No.: US 2024/0168757 A1
(43) Pub. Date: May 23, 2024

(54) SOFTWARE CODE CONSOLIDATION

(71) Applicant: BRITISH TELECOMMUNICATIONS PUBLIC LIMITED COMPANY, London (GB)

(72) Inventors: Alistair MCCORMICK, London (GB); Adam ZIOLKOWSKI, London (GB); Emmanuel FERREYRA OLIVARES, London (GB); Johannes NOPPEN, London (GB)

(21) Appl. No.: 18/551,466

(22) PCT Filed: Mar. 10, 2022
(86) PCT No.: PCT/EP2022/056232

§ 371 Date: Sep. 20, 2023

(30) Foreign Application Priority Data
Mar. 22, 2021 (GB) 2103920.1

(51) Int. Cl. G06F 8/72; G06F 8/35

(52) U.S. Cl. CPC G06F 8/72; G06F 8/35

(57) ABSTRACT

A computer implemented method to generate a software service from software code for a software component, the method including converting the code to a model representation, the model including elements corresponding to functional components in the code and relationships between elements corresponding to one or more of functional links and data relationships between the functional components; applying a clustering method to the model to define a plurality of clusters of elements of the model, each cluster of elements representing a set of functional components in the code corresponding to the elements in the cluster; monitoring the software code in execution to identify a set of functional components in the code corresponding to a cluster of elements in which the set of functional components is collectively stateless between executions of any of the functional components in the set; and generating a software service as an executable software component comprising the identified set of functional components.

### PRIORITY CLAIM

The present application is a National Phase entry of PCT Application No. PCT/EP2022/056232, filed Mar. 10, 2022, which claims priority from GB Patent Application No. 2103920.1, filed Mar. 22, 2021, each of which is hereby fully incorporated herein by reference.

### TECHNICAL FIELD

The present disclosure relates to the consolidation of software code by the generation of software services.

### BACKGROUND

With an increasing transition of software to cloud service providers and the growing containerization of software into discrete software services that can interconnect through defined common interfaces, there is a growing need to generate new such services (also known as microservices) such as by new software development or the adaptation of existing software, such as legacy software systems.

Existing software, such as legacy software, includes potentially many functionalities that require analysis and refactoring for redeployment, revision, upgrade, adaptation, service and/or maintenance. The process of analyzing such software to understand its design, architecture, components, arrangement and the functions of its elements is typically time-consuming and largely manual. To the extent that technical facilities can assist with such analysis, facilities are typically limited to modelling software such as by conversion or projection of software in a modelling format such as unified modelling language (UML) diagrams or the like. While such an approach can assist with the analysis process, it is still a considerable manual step to analyze such generated models which, in the case of large software systems, can be vast in scale. In some cases, the cost and effort required to analyze such software can render it more appropriate to redevelop software from scratch.

### SUMMARY

Accordingly, there is a need to improve the analysis and adaptation of existing software.

According to a first aspect of the present disclosure, there is provided a computer implemented method to generate a software service from software code for a software component, the method comprising: converting the code to a model representation, the model including elements corresponding to functional components in the code and relationships between elements corresponding to one or more of functional links and data relationships between the functional components; applying a clustering method to the model to define a plurality of clusters of elements of the model, each cluster of elements representing a set of functional components in the code corresponding to the elements in the cluster; monitoring the software code in execution to identify a set of functional components in the code corresponding to a cluster of elements in which the set of functional components is collectively stateless between executions of any of the functional components in the set; and generating a software service as an executable software component comprising the identified set of functional components.

In some embodiments, the software code is one or more of: source code; object code; and intermediate code.

In some embodiments, the clustering method defines the plurality of clusters based on one or more characteristics of functional components in the code corresponding to elements in the model including: execution trace information for the software component; a classification of each of the functional components of the software component; a classification of one or more functions called by one or more functional components of the software component; a classification of one or more interfaces used by one or more functional components of the software component; data accessed by one or more functional components of the software component; data stored by one or more functional components of the software component; and maintenance data for one or more functional components of the software component.

In some embodiments, the stateless set of functional components are identified by a determination that no functional component in the set involves data storage to a data store having a scope exceeding the stateless set of functional components.

In some embodiments, the data store includes one or more of: a database; a file; and a persistent storage.

In some embodiments, the identified set of functional components in the software code are removed from the software code and replaced by an interface to the generated software service.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement to generate a software service from software code for a software component in accordance with embodiments of the present disclosure.

FIG. 3 is a flowchart of a method to generate a software service from software code for a software component in accordance with embodiments of the present disclosure.

### DETAILED DESCRIPTION

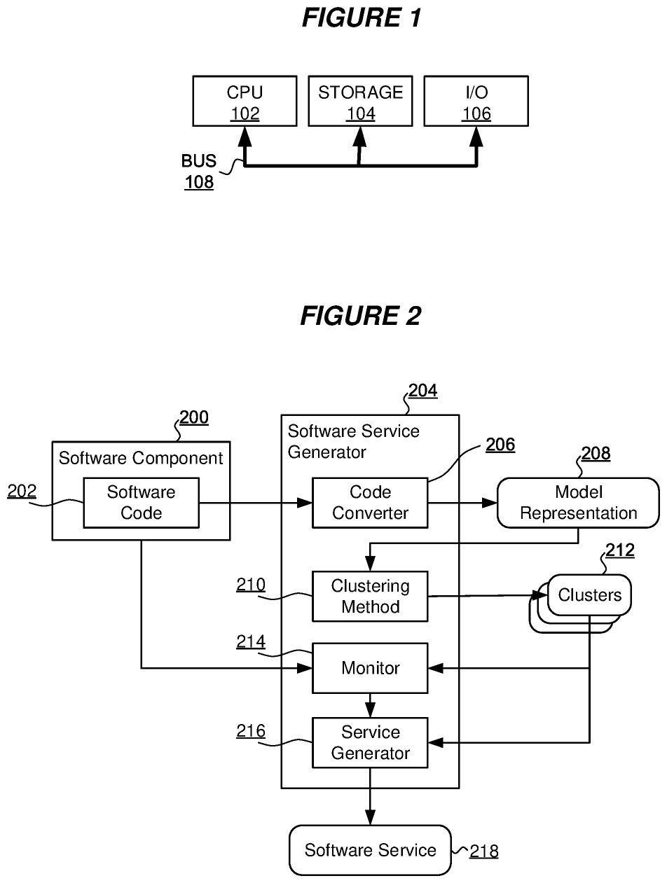

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement to generate a software service from software code 202 for a software component 200 in accordance with embodiments of the present disclosure. The software component 200 is an executable software component such as a user application, an enterprise, a software client, a software service, a suite of executable libraries for interfacing with other software components and other software arrangements as will be apparent to those skilled in the art. The software code 202 is source, intermediate, object or other code as will be apparent to those skilled in the art. At least where the software code 202 is object code, the code 202 is provided with additional features for discerning one or more of, inter alia, the: nature; structure; constituents; functions; procedures; methods; classes; data interfaces; functional interfaces; and other characteristics of the software code suitable to permit the software code to be analyzed for conversion to a model representation as described below. For example, software code 202 as object code can be provided with debugging information or the like.

A software service generator 204 is provided as a hardware, software, firmware or combination component arranged to generate a software service 218 based on the software code 202 in the software component 200. The software service 218 is a discrete executable software component providing at least a portion of the functionality of the software component 200. Thus, when generated, the software component 200 obviates a need for inclusion of the functionality of the software service 218 in the software component 200. Consequently, on generation of the software service 218, such functionality can be excluded from analysis of the software component 200 and/or removed from, or indicated for removal or exclusion in, the software component 200. In some embodiments, the software code 202 is adapted to include an interface to the software service 218 such that the functionality of the software service 218 is available to the software component 202 via the interface.

The software service generator 204 includes a code converter 206 as a hardware, software, firmware or combination component operable to convert the software code 202 to a model representation 208. The model representation is a representation of the software code 202 including elements corresponding to functional components in the code 202 such as functions, procedures, subroutines, classes, methods or the like. Further, the model representation includes indications of relationships between elements corresponding to relationships between functional components in the code 202 such as functional links and/or data relationships. For example, where a first function in the code 202 calls a second function, an indication of the functional relationship is indicated in the model representation. Similarly, indications of relationships are generated where, for example, inter alia: a first class is inherited from a second class; a pair of subroutines access a common data area or item; a first routine interfaces to a second routine; and other such relationships as will be apparent to those skilled in the art. For example, in one embodiment, the model representation 208 is a visual model such as a UML model generated by software adapted to convert code to UML as is known in the art.

The software service generator 204 further includes a clustering method 210 as a facility for clustering the elements of the model representation 208 so as to generate a plurality of clusters 212 of elements, each element corresponding to a functional component in the software code 202. The clustering method defines the plurality of clusters based on one or more characteristics of functional components in the code 202 corresponding to elements in the model 208 including: execution trace information for the software component 200; a classification of each of the functional components of the software component 200; a classification of one or more functions called by one or more functional components of the software component 200; a classification of one or more interfaces used by one or more functional components of the software component 200; data accessed by one or more functional components of the software component 200; data stored by one or more functional components of the software component 200; and maintenance data for one or more functional components of the software component 200.

The software service generator further includes a monitor component 214 is a hardware, software, firmware or combination component arranged to execute, or have executed, the software code 202 and monitor the execution thereof to identify a set of functional components in the code 202 corresponding to a cluster of elements in the clusters 212 in which the set of functional components is collectively stateless between executions of any of the functional components in the set. Thus, the monitor 214, recognizing the functional components indicated by elements in each cluster 212, identifies a stateless set of functional components corresponding to a cluster 212. For example, a stateless set of functional components can be identified by a determination that no functional component in the set involves data storage to a data store having a scope exceeding the stateless set of functional components. Such scope, as is known to those skilled in the art, constitutes a visibility of data within the software code 202 such that data is accessible only to functional components within scope of visibility of the data. For example, the data store can include, inter alia, one or more of: a database; a file; and a persistent data store or storage. Thus, a set of functional elements identified by the monitor 214 that is collectively stateless and that corresponds to a cluster 212 of elements constitutes a candidate for generation of a software service because software services are stateless functional services accessible via an interface and operable on data communicated via such interface.

The software service generator 204 accordingly includes a service generator 216 as a hardware, software, firmware or combination component arranged to generate the software service 218 as an executable software component comprising the set of functional components corresponding to a cluster 212 identified by the monitor 214.

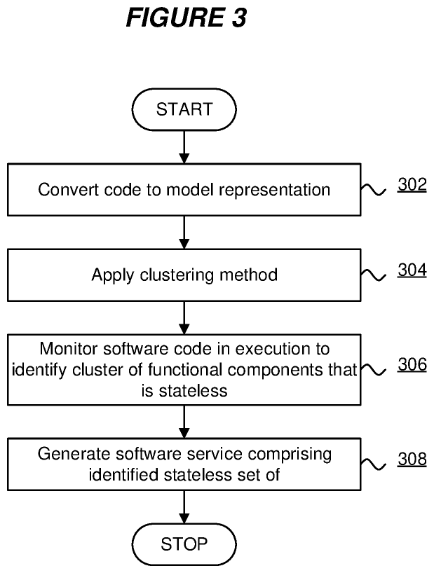

FIG. 3 is a flowchart of a method to generate a software service from software code for a software component in accordance with embodiments of the present disclosure. Initially, at 302, the method converts the software code 202 of the software component 200 to a model representation 208 including elements corresponding to functional components in the code 202 and relationships between elements corresponding to one or more of functional links and data relationships between the functional components. At 304 the method applies a clustering method to the model representation 208 to define clusters 212 of elements of the model 208. Each cluster 212 of elements represents a set of functional components in the code 202 corresponding to the elements in the cluster. At 306 the method executes, or has executed, the software code 202 to identify a set of functional components in the code 202 corresponding to a cluster 212 of elements in which the set of functional components is collectively stateless between executions of any of the functional components in the set. Subsequently, at 308, the method generates a software service 128 as an executable software component including the identified set of functional components.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the claims.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method to generate a software service from software code for a software component, the method comprising:
converting the software code to a model representation, the model representation including elements corresponding to functional components in the software code and relationships between elements corresponding to one or more of functional links and data relationships between the functional components;
applying a clustering method to the model representation to define a plurality of clusters of elements of the model representation, each of the plurality of clusters of elements representing a set of functional components in the software code corresponding to the elements in the respective cluster;
monitoring the software code in execution to identify a set of functional components in the software code corresponding to a cluster of elements in which a set of functional components is collectively stateless between executions of any of the functional components in the set; and
generating a software service as an executable software component comprising the identified set of functional components.

2. The method of claim 1, wherein the software code is one or more of: source code; object code; or intermediate code.

3. The method of claim 1, wherein the clustering method defines the plurality of clusters based on one or more characteristics of functional components in the software code corresponding to elements in the model including: execution trace information for the software component; a classification of each of the functional components of the software component; a classification of one or more functions called by one or more functional components of the software component; a classification of one or more interfaces used by one or more functional components of the software component; data accessed by one or more functional components of the software component; data stored by one or more functional components of the software component; and maintenance data for one or more functional components of the software component.

4. The method of claim 1, wherein the stateless set of functional components are identified by a determination that no functional component in the set involves data storage to a data store having a scope exceeding the stateless set of functional components.

5. The method of claim 4, wherein the data store includes one or more of: a database; a file; or a persistent storage.

6. The method of claim 1, wherein the identified set of functional components in the software code are removed from the software code and replaced by an interface to the generated software service.

7. A computer system comprising:
a processor and memory storing computer program code for generating a software service from software code for a software component by:
converting the software code to a model representation, the model representation including elements corresponding to functional components in the software code and relationships between elements corresponding to one or more of functional links and data relationships between the functional components;
applying a clustering method to the model representation to define a plurality of clusters of elements of the model representation, each of the plurality of clusters of elements representing a set of functional components in the software code corresponding to the elements in the respective cluster;
monitoring the software code in execution to identify a set of functional components in the software code corresponding to a cluster of elements in which a set of functional components is collectively stateless between executions of any of the functional components in the set; and
generating a software service as an executable software component comprising the identified set of functional components.

8. A non-transitory computer-readable storage element comprising computer program code to, when loaded into a computer system and executed thereon, cause the computer system to generate a software service from software code for a software component by:
converting the software code to a model representation, the model representation including elements corresponding to functional components in the software code and relationships between elements corresponding to one or more of functional links and data relationships between the functional components;
applying a clustering method to the model representation to define a plurality of clusters of elements of the model representation, each of the plurality of clusters of elements representing a set of functional components in the software code corresponding to the elements in the respective cluster;
monitoring the software code in execution to identify a set of functional components in the software code corresponding to a cluster of elements in which a set of functional components is collectively stateless between executions of any of the functional components in the set; and
generating a software service as an executable software component comprising the identified set of functional components.
